(19) United States
(12) Patent Application Publication
(10) Pub. No.: US 2008/0301259 A1
(43) Pub. Date: Dec. 4, 2008

(54) METHOD AND SYSTEM FOR ACCESSING A BUSINESS OBJECT BY USING A SERVICE PROVIDER CLASS

(76) Inventor: Herbert Hackmann, Wiesloch (DE)

Correspondence Address: SAP AG, 3410 HILLVIEW AVENUE, PALO ALTO, CA, 94304, US

(21) Appl. No.: 11/757,431

(22) Filed: Jun. 4, 2007

(51) Int. Cl. G06F 15/173

(52) U.S. Cl. 709/218

(57) ABSTRACT

Disclosed is a method and system for receiving a request at an object, retrieving a node identification (ID) of a node of the object from the request and fetching an instance of a service provider class of the node from a service provider class factory based on the node ID, and processing the request at the object by accessing a method in the service provider class of the node.

### FIELD OF THE INVENTION

The invention relates to the field of enterprise software applications and more specifically to a way of accessing core services of a business object by using a service provider class in the enterprise application.

### BACKGROUND OF THE INVENTION

A business object typically contains one or more nodes. The nodes of the business object may be accessed by a service provider class. The service provider class provides basic functions such as create, retrieve, update, and delete on the business object and business object nodes. Typically, there would be only one service provider class that would provide access to the business object and all the business object nodes. Such a service provider class typically contains a significantly large amount of code since the service provider class has the code to access all the nodes in the business object.

For example, consider a business object that has 10 nodes, and a service provider class that provides operations such as create, retrieve, update, and delete for all the 10 nodes in the business object. Considering each of the operations would take at least 25 lines of code, then the service provider class would typically have 100 lines of code for one node in the business object. For 10 nodes, the service provider class would have 1000 lines of code. Maintaining a single service provider class for all the business object nodes is typically tedious and not efficient. It would be very time consuming for the developers of the service provider class to debug a problem in the service provider class with so many lines of code and if the problem is not debugged properly, the chances of a programming error being left out in the code may increase. Also, having a single service provider class that performs different operations on different nodes in different ways may not be a good object oriented design. Object oriented design recommends a modular approach in designing a solution to a problem. A modular approach such as breaking up one large service provider class into smaller service provider classes would typically decrease the problems faced in debugging. A modular approach would make it easier for the developers to debug a problem in the service provider class which is relatively smaller than one single service provider class for the business object.

### SUMMARY OF THE INVENTION

What is described is a method and system for accessing a business object using a service provider class. The method includes receiving a request at an object, retrieving a node identification (ID) of a node of the object from the request. An instance of the service provider class of the node is fetched from a service provider class factory based on the node ID, and the request at the object is processed by accessing a method in the service provider class of the node.

### BRIEF DESCRIPTION OF THE DRAWINGS

FIG. 1 is a block diagram of a business object according to an embodiment of the invention.

FIG. 2 is a block diagram of a service provider class to access a business object according to an embodiment of the invention.

FIG. 3 is a flow diagram to access a business object by using a service provider class according to an embodiment of the invention.

FIG. 4 is a flow diagram to fetch an instance of a service provider class from a service provider class factory according to an embodiment of the invention.

FIG. 5 is a block diagram of a system to access a business object using a service provider class of a node according to an embodiment of the invention.

FIG. 6 is a block diagram of various components of a system to access a business object using a service provider class of a node according to an embodiment of the invention.

### DETAILED DESCRIPTION

What is described is a method and system for accessing a business object using a service provider class. A request is received at an object and a node identification (ID) of a node if the object is retrieved from the request. An instance of a service provider class of the node is fetched from a service provider class factory based on the node ID, and the request at the object is processed by accessing a method in the service provider class. The object includes a business object. It is typically more efficient to have a service provider class that provides access to a node than having a service provider class at the business object level that provides access to all nodes of the business object.

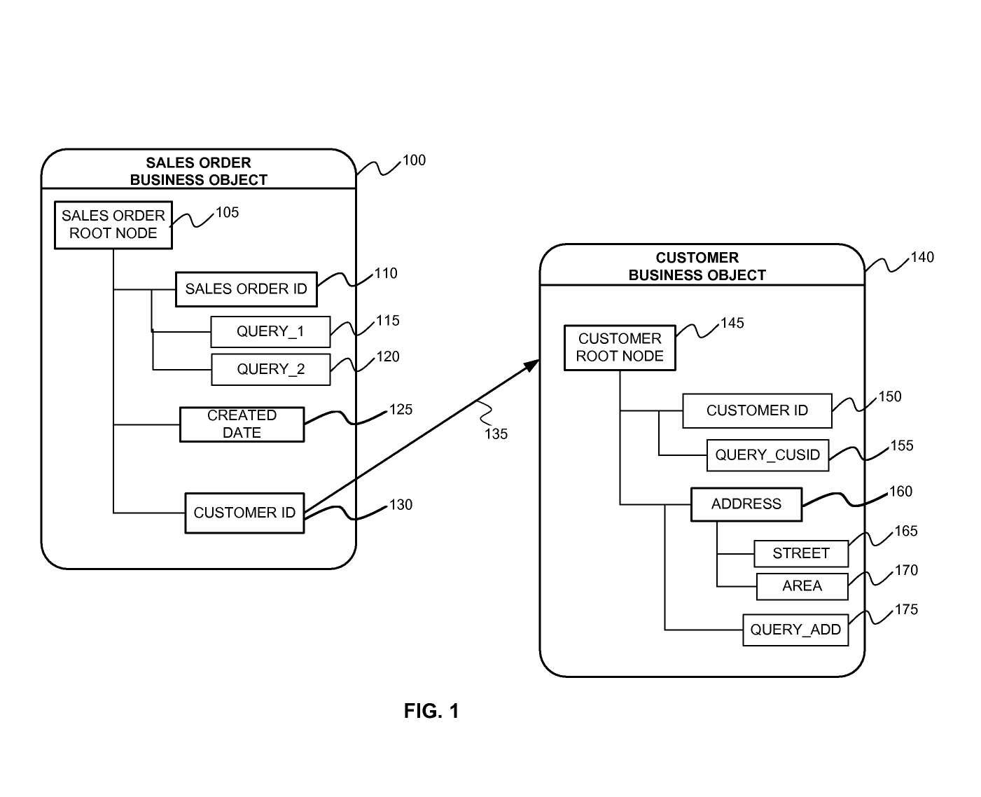

FIG. 1 is a block diagram of a business object according to an embodiment of the invention. A business object represents a category of unique, identifiable business entities. Sales Order business object 100 and Customer business object 140 are two examples of business entities. The business object has one or more nodes which represent attributes or properties of the business object. Sales Order business object 100 has nodes such as sales order root node 105, sales order ID 110, created date 125, and customer ID 130. Customer business object 140 has nodes such as customer root node 145, customer ID 150, and address 160. The hierarchy of the nodes is produced through associations between the nodes starting with the customer root node 145. Each node groups together semantically related attributes, for example, the node address 160 groups attributes such as street 165 and area 170. A node may also include a query, an association and a dependent business object.

The node sales order ID 110 includes queries such as query_1 115 and query_2 120. Similarly, in Customer business object 140, the node customer ID 150 includes query_cusid 155 and the node address 160 includes query_add 175. A query fetches data of a particular node based on a condition specified in the query. For example, in Customer business object 140, query_add 175 on the node address 160 may fetch an address of a customer whose customer_ID 150 is specified in query_add 175.

The node customer ID 130 has an association 135 with Customer business object 140. In a sales scenario, a sales order cannot exist without any customer assigned to the sales order. Thus, Sales Order business object 100 is associated with Customer business object 140 and in particular, node customer ID 130 in Sales Order business object 100 has an association 135 with node customer ID 150 in Customer business object 140.

A dependent business object is a business object which can be used when embedded in another business object. For example, node address 160 in Customer business object 140 is a dependent business object. An instance of the dependent business object cannot be created separately. The instance of the dependent business object can be created when the instance of the business object it is embedded in is created. The dependent business object may have zero or more embedded dependent business objects.

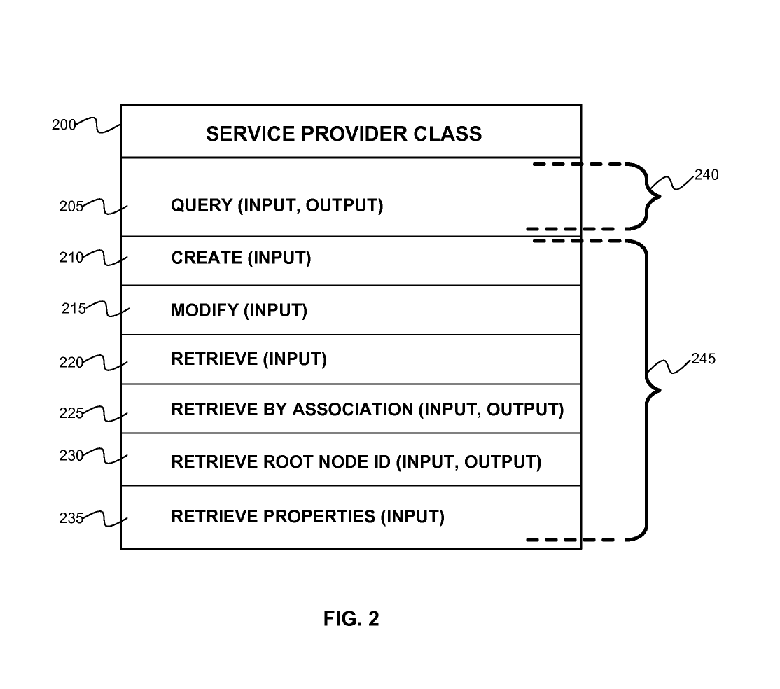

FIG. 2 is a block diagram of a service provider class to access a business object according to an embodiment of the invention. A service provider class 200 provides a set of services known as core services which provide direct access to the business object typically to manipulate data of the business object. The core services include query 205, create 210, modify 215, retrieve 220, retrieve by association 225, retrieve root node ID 230, and retrieve properties 235. The core services provided by service provider class 200 are derived from interface patterns such as query interface pattern 240 and access interface pattern 245 in enterprise service oriented architecture provided by SAP AG. Service oriented architecture (SOA) supports the design, development, identification and consumption of standardized software services across an enterprise, thereby improving reusability and flexibility of software components.

Query interface pattern 240 includes core service method query 240. Access interface pattern 245 includes core service methods such as create 210, modify 215, retrieve 220, retrieve by association 225, retrieve root node ID 230, and retrieve properties 235. A description of the methods of the service provider class 200 is given below.

### Methods of Service Provider Class

Query 205: Returns a list of node identifications (IDs) for a selection criteria specified in the input parameter of the method query 205. The method query 205 typically acts on data that is already persisted in a database.

Create 240: The method create 240 is a mode of the method Modify 215 which creates a new business object node element of the node ID specified in the input parameter of the method create 210.

Modify 215: The method modify 215 performs actions like creating, updating, and deleting data. Modify 215 typically performs all requested data changes on transaction data that are in a temporary buffer and not persisted in a database.

Retrieve 220: The method retrieve 220 returns a node ID and a list of node elements for the node ID specified in the input parameter of the method retrieve 220. Retrieve 220 typically works on transactional data that is in a temporary buffer.

Retrieve by association 225: The method retrieve by association 225 returns dependent data that results from a specified association for a node ID specified in the input parameter of the method retrieve by association 225.

Retrieve root node ID 230: The method retrieve root node ID 230 returns an instance of a root node of a business object instance specified in the input parameter of the method retrieve root node ID 230.

Retrieve properties 235: The method retrieve properties 235 retrieves settings of properties for a node ID specified in the input parameter of the method retrieve properties 235.

The methods of the service provider class 200 described above contain one or more input parameters and zero or more output parameters. Service provider class 200 may be registered for a node in the business object. In one embodiment, there may be one service provider class registered for every node, query, and association in the business object. In another embodiment, a service provider class may be registered for only few nodes in the business object. The rest of the nodes in the business object may be accessed via a default service provider class.

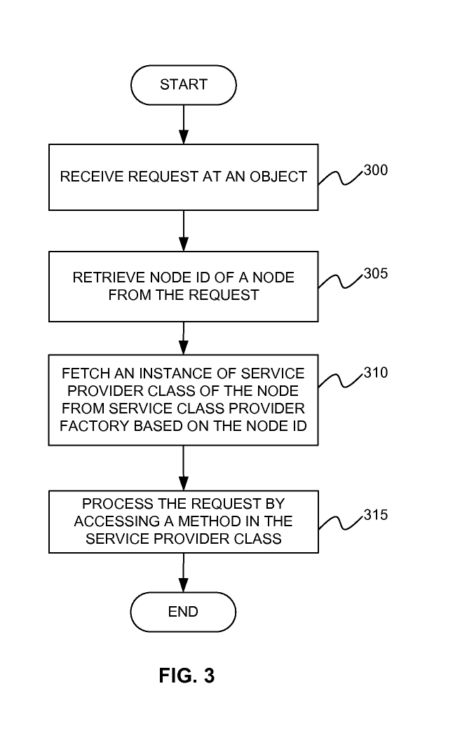

FIG. 3 is a flow diagram to access a business object by using a service provider class according to an embodiment of the invention. At step 300, a request is received at a business object. The request may include a query operation, a retrieve operation, a create operation, an update operation and a delete operation on a node. A node ID of a node of the business object is retrieved from the request at step 305. The node ID may include an ID of a node, a query, an association, or a dependent object. After the node ID is retrieved, at step 310 an instance of a service provider class of the node is fetched from a service provider class factory based on the node ID. The request at the business object is processed by accessing a method in the service provider class as depicted in step 315.

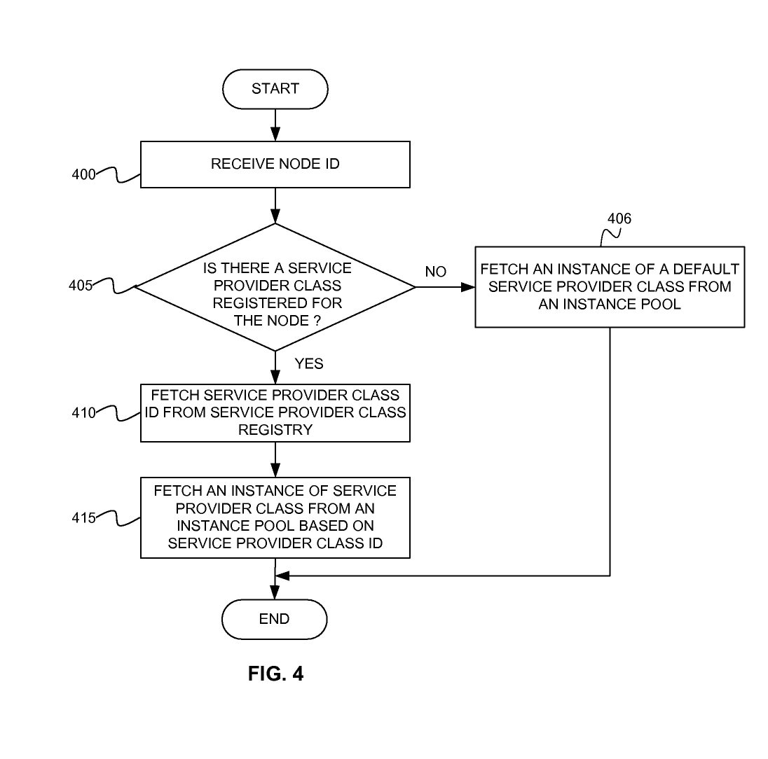

FIG. 4 is a flow diagram to fetch an instance of a service provider class from a service provider class factory according to an embodiment of the invention. A node ID is received at a factory framework in step 400. In step 405, the factory framework makes a determination by checking if a service provider class is registered in a service provider class registry for the node ID. If the service provider class is registered in the service provider class registry, then the factory framework fetches a service provider class ID of the service provider class as depicted in step 410. At 415, the factory framework fetches an instance of the service provider class from an instance pool of the service provider class factory based on the service provider class ID fetched in step 440. If at step 405, the factory framework does not find any service provider class registered for the node ID received in step 400, then at step 406 an instance of a default service provider class is fetched from the instance pool of the service provider class factory.

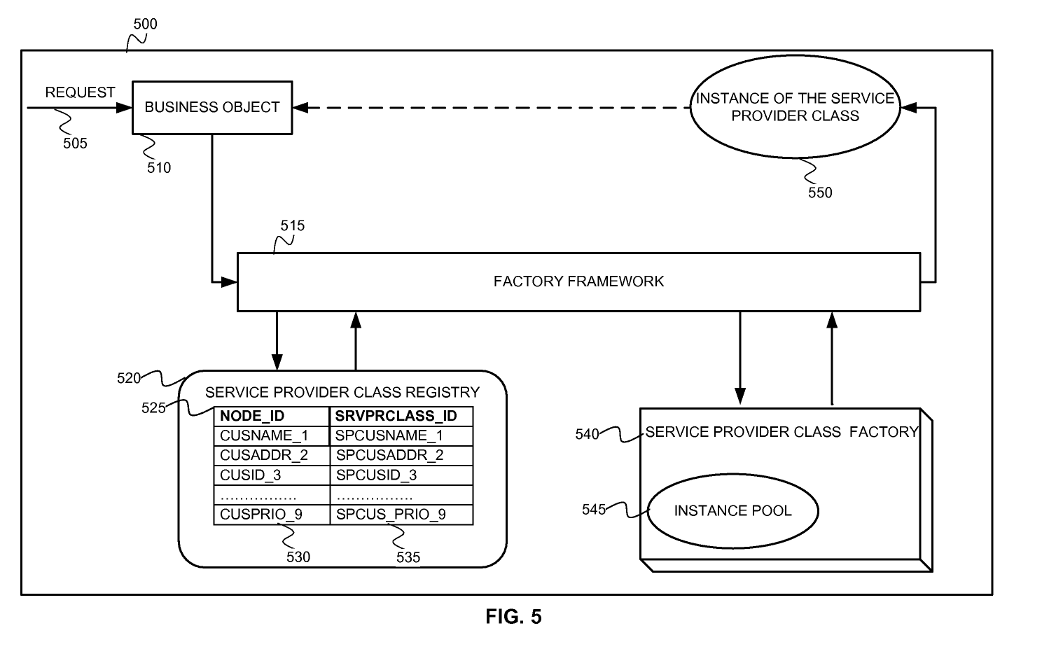

FIG. 5 is a block diagram of a system to access a business object using a service provider class of a node according to an embodiment of the invention. System 500 includes a business object 510 at which request 505 is received. The request 505 may include a query, create, update, or delete operation on a node of business object 510. A node identification (ID) of the node in business object 510 is retrieved from request 505. Node ID may include a query ID, an association ID, or a dependent object ID. A service provider class 200 as shown in FIG. 2 may be registered for the node in service provider class registry 520.

Service provider class registry 520 has a table 525 that contains registrations of service provider classes for the nodes. Table 525 contains a list of node IDs 530 and corresponding service provider class ID 535 of the service provider classes registered for the node IDs 530. The node which does not have a service provider class 200 registered may be accessed by a default service provider class. The default service provider class provides methods to access the node of the business object which does not have the service provider class registered in the service provider class registry 520.

Factory framework 515 receives node ID from business object 510 and checks service provider class registry 520 if service provider class 200 is registered for node ID. If service provider class 200 is registered for node ID, then factory framework 515 fetches the service provider class ID of the service provider class 200 from service provider class registry 520. Factory framework 515 then fetches an instance of the service provider class 550 from service provider class factory 540 based on service provider class ID. If there is no service provider class 200 registered for node ID, then factory framework 515 fetches an instance of a default service provider class 550 from the service provider class factory 540. The service provider class factory 540 fetches the instance of service provider class from an instance pool 545 where an instance of service provider class is stored. If the instance of the service provider class 550 does not exist in instance pool 545, then service provider class factory 540 creates an instance of the service provider class 550 in instance pool 545. The instance of the service provider class 550 has methods that include query 205, create 210, modify 215, retrieve 220, retrieve by association 225, retrieve root node ID 230 and retrieve properties 235 as shown in FIG. 2. Request 505 at business object 510 may be processed by accessing a method from instance of the service provider class 550.

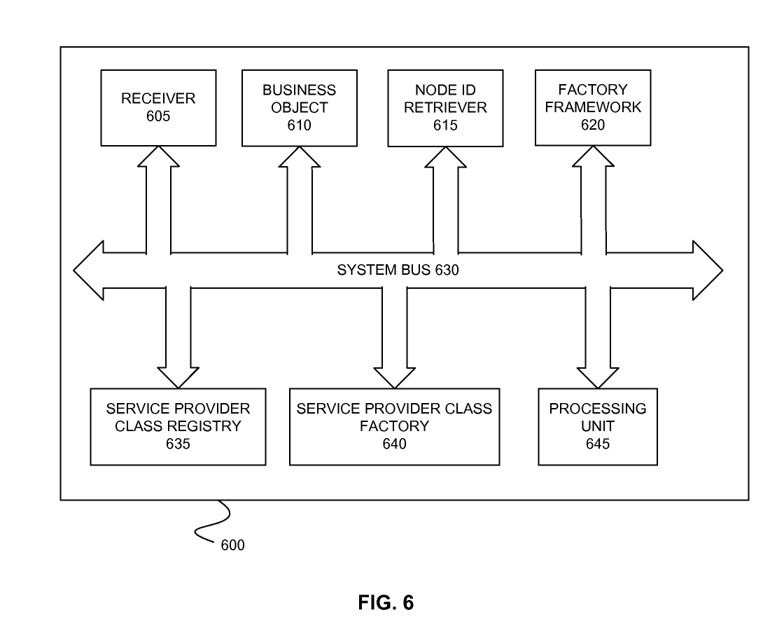

FIG. 6 is a block diagram of various components of a system to access a business object using a service provider class of a node according to an embodiment of the invention. System 600 includes various components such as receiver 605, business object 610, node ID retriever 615, factory framework 620, service provider class registry 635, service provider class factory 640, and processing unit 645 all electronically coupled to system bus 630. It may be obvious to one skilled in the art that the above components may be connected to each other in any other manner so as to achieve the same result as the one achieved by the components in this figure. Receiver 605 receives the request at business object 610. The request is passed to node ID retriever 615 to retrieve a node ID from the request. The node ID is then passed to factory framework 620 to fetch a service provider class for the node ID. Factory framework 620 checks service provider class registry 635 if a service provider class is registered for the node ID. If the service provider class is registered for the node ID, then the factory framework 620 fetches a service provider class ID of the service provider class registered for the node ID from service provider class registry 635. Factory framework 620 then fetches an instance of the service provider class from the service provider class factory 640 based on the service provider class ID. If the service provider class is not registered for the node ID in service provider class registry 635, then factory framework 620 fetches an instance of a default service provider class from the service provider class factory 640. The processing unit 645 receives the instance of the service provider class and processes the request on business object 610 by accessing a method in the instance of the service provider class.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or any other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A method, comprising:
receiving a request at an object;
retrieving a node identification (ID) of a node of the object from the request;
fetching an instance of a service provider class of the node from a service provider class factory based on the node ID; and
processing the request at the object by accessing a method in the service provider class of the node.

2. The method in claim 1, further comprising registering the service provider class of the node in a service provider class registry.

3. The method in claim 1, wherein the object comprises a business object.

4. The method in claim 1, wherein the node of the object comprises an entity selected from a group consisting of a query on the node, an association of the node with another object, an attribute, and a dependent object.

5. The method in claim 1, where in the node ID comprises an attribute selected from a group consisting of a name of the node, a name of a query on the node, a name of an association of the node, a unique number of the node, a unique number of the query, and a unique number of the association.

6. The method in claim 1, wherein fetching the instance of the service provider class of the node comprises:
checking a service provider class registry for the service provider class based on the node ID;
fetching a service provider class ID of the service provider class from the service provider class registry based on the node ID; and
fetching the instance of the service provider class from the service provider class factory based on the service provider class ID.

7. The method in claim 6, further comprising fetching the instance of a default service provider class from the service provider class factory if there is no service provider class registered for the node in the service provider class registry.

8. The method in claim 1, wherein fetching the instance of the service provider class of the node from the service provider class factory comprises fetching the instance of the service provider class from an instance pool in the service provider class factory.

9. The method in claim 8, further comprising creating the instance of the service provider class if the instance of the service provider class does not exist in the instance pool.

10. The method in claim 1, wherein processing the request at the object by accessing a method in the service provider class of the node comprises accessing a core service selected from a group consisting of create, retrieve, retrieve by association, update, and delete provided by the object.

11. A system, comprising:
a receiver to receive a request at an object;
a node identification (ID) retriever to retrieve a node ID of a node of the object from the request;
a factory framework to fetch an instance of a service provider class of the node from a service provider class factory based on the node ID; and
a processing unit to process the request at the object by accessing a method in the service provider class.

12. The system in claim 11, wherein the service provider class factory further comprises an instance pool that contains an instance of the service provider class of the node.

13. The system in claim 11 further comprising a service provider class registry to register the service provider class of the node.

14. The system in claim 11, where in the object, the node ID retriever, the factory framework, the service provider class factory, the processing unit, and a service provider class registry are electronically coupled to a system bus.

15. An article of manufacture, comprising:
a machine readable medium having instructions which when executed by a machine cause the machine to:
receive a request at an object;
retrieve a node identification (ID) of a node of the object from the request;
fetch an instance of a service provider class of the node from a service provider class factory based on the node ID; and
process the request at the object by accessing a method in the service provider class of the node.

16. The article of manufacture in claim 15, wherein the machine readable medium provides instructions, which when executed by a machine cause the machine to
check a service provider class registry for the service provider class based on the node ID;
fetch a service provider class ID of the node from the service provider class registry based on the node ID; and
fetch the instance of the service provider class from the service provider class factory based on the service provider class ID.

17. The article of manufacture in claim 15, wherein the machine readable medium provides instructions, which when executed by a machine cause the machine to fetch the instance of the service provider class from an instance pool in the service provider class factory.

18. The article of manufacture in claim 15, wherein the machine readable medium provides instructions, which when executed by a machine cause the machine to access a core service selected from a group consisting of create, retrieve, retrieve by association, update, and delete provided by the object for the node.
